(19) United States
(12) Patent Application Publication
(10) Pub. No.: US 2024/0240062 A1
(43) Pub. Date: Jul. 18, 2024

(54) (METH)ACRYLATE-BASED TWO-PART ADHESIVE COMPOSITION

(71) Applicant: Henkel AG & Co. KGaA, Duesseldorf (DE)

(72) Inventors: Chongyang Sun, Shanghai (CN); Chongjian Song, Shanghai (CN); Zuohe Wang, Shanghai (CN)

(21) Appl. No.: 18/622,466

(22) Filed: Mar. 29, 2024

Related U.S. Application Data
(63) Continuation of application No. PCT/CN2021/121547, filed on Sep. 29, 2021.

(51) Int. Cl. C09J 133/10; C09J 4/00; C09J 5/06; C09J 11/06

(52) U.S. Cl. CPC C09J 133/10; C09J 4/00; C09J 5/06; C09J 11/06; C09J 2301/304; C09J 2301/408; C09J 2433/00

(57) ABSTRACT

The present invention provides a (meth)acrylate-based two-part adhesive composition, comprising: a first part comprising: at least one amine-aldehyde condensation compound, and a second part comprising: at least one organic transitional metal compound and at least one phosphorus-containing compound, wherein the first part and/or the second part further comprise at least one (meth)acrylate monomer containing at least one hydroxyl group per molecule. The present invention also provides a method for bonding a first substrate to a second substrate with the (meth)acrylate-based two-part adhesive composition, and an article bonded by the (meth)acrylate-based two-part adhesive composition, or obtained by the method.

### TECHNICAL FIELD

The present invention relates to a (meth)acrylate-based two-part adhesive composition. In particular, the (meth)acrylate-based two-part adhesive composition comprises: a first part comprising: at least one amine-aldehyde condensation compound, and a second part comprising: at least one organic transitional metal compound and at least one phosphorus-containing compound, wherein the first part and/or the second part further comprise at least one (meth)acrylate monomer containing at least one hydroxyl group per molecule.

### BACKGROUND OF THE INVENTION

Redox-initiator (meth)acrylate-based structural adhesives have been commonly used in various industrial sectors. However, in a conventional (meth)acrylate-based adhesive composition, redox-initiator system generally comprises a toxic and/or unstable peroxide, and/or a toxic aromatic/aliphatic amine.

Moreover, gel time, peak exothermic temperature, peak exothermic time and bonding strength of a (meth)acrylate-based two-part adhesive are several important parameters for the application of this adhesive.

Therefore, there is a need to develop a (meth)acrylate-based two-part adhesive composition which is human friendly, and exhibits short gel time and/or peak exothermic time, and/or high peak exothermic temperature and/or bonding strength.

### SUMMARY OF THE INVENTION

In accordance with a first aspect of the invention, there is provided a (meth)acrylate-based two-part adhesive composition, comprising: a first part comprising: at least one amine-aldehyde condensation compound, and a second part comprising: at least one organic transitional metal compound and at least one phosphorus-containing compound, wherein the first part and/or the second part further comprise at least one (meth)acrylate monomer containing at least one hydroxyl group per molecule.

In accordance with a second aspect of the present invention, there is provided a method for bonding a first substrate to a second substrate, comprising: mixing the two parts of the (meth)acrylate-based two-part adhesive composition of the present invention; applying the mixed adhesive composition to at least one of the substrate surfaces to be bonded; joining the substrates to be bonded in a way that the adhesive composition is between the substrates; and curing the adhesive composition.

In accordance with a third aspect of the present invention, there is provided an article bonded by the (meth)acrylate-based two-part adhesive composition of the present invention, or obtained by the method of the present invention.

As compared with the prior art, the (meth)acrylate-based two-part adhesive composition is human friendly, and exhibits short gel time and/or peak exothermic time, and/or high peak exothermic temperature and/or bonding strength.

### DETAILED DESCRIPTION OF THE INVENTION

It is to be understood by one of ordinary skill in the art that the present discussion is a description of exemplary embodiments only, and is not intended as limiting the broader aspects of the present invention. Each aspect so described may be combined with any other aspect or aspects unless clearly indicated to the contrary. In particular, any feature indicated as being preferred or advantageous may be combined with any other feature or features indicated as being preferred or advantageous.

Unless specified otherwise, as used herein, all wt. % values are percentages by weight based on total weight of the part in which the corresponding component is present.

Unless specified otherwise, as used herein, the singular forms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements or process steps.

Unless specified otherwise, the recitation of numerical end points includes all numbers and fractions subsumed within the respective ranges, as well as the recited end points.

Unless otherwise defined, all terms used in the disclosing the invention, including technical and scientific terms, have the meaning as commonly understood by one of the ordinary skill in the art to which this invention belongs. By means of further guidance, term definitions are included to better appreciate the teaching of the present invention.

As used herein, the term “(meth)acrylate” refer to “acrylate” and “methacrylate”.

As used herein, the term “(meth)acrylic” refers to “acrylic” and “methacrylic”.

According to the present invention, surprisingly, the (meth)acrylate-based two-part adhesive composition, comprising: a first part comprising: at least one amine-aldehyde condensation compound, and a second part comprising: at least one organic transitional metal compound and at least one phosphorus-containing compound, wherein the first part and/or the second part further comprise at least one (meth)acrylate monomer containing at least one hydroxyl group per molecule, is human friendly, and exhibits short gel time and/or peak exothermic time, and/or high peak exothermic temperature and/or bonding strength.

Preferably, the (meth)acrylate-based two-part adhesive composition is free from peroxide and/or amine, and preferably is free from peroxide and amine.

### Amine-Aldehyde Condensation Compound

In the present invention, amine-aldehyde condensation compound refers to an amine-aldehyde condensation product, which is obtained by reacting an aldehyde with an amine, regardless of the ratio of aldehyde to amine which is used. A description of the amine-aldehyde condensation compound can be found in the following U.S. Pat. No. 1,780,334 to Burnett et al., issued on Nov. 4, 1930; 1,908,093 to Williams, issued on May 9, 1933; and U.S. Pat. No. 2,578,690 to Gerhart, issued on Dec. 18, 1951. The amine-aldehyde condensation compound can be any one which is conventionally used as a reducing agent in a structural adhesive composition.

Preferably, the amine-aldehyde condensation compound is obtained from the reaction mixture which contains at least one mole of aldehyde for each mole of amine which is used. More preferably, the reaction mixture contains from about 1.0 to about 3.5 moles of aldehyde for each mole of amine which is used and most preferably from about 1.5 to about 3.0 moles of the aldehyde for each mole of the amine.

The aldehyde used in the amine-aldehyde condensation product may be selected from the group consisting of aromatic aldehydes (such as benzaldehyde and naphthaldehyde) and aliphatic aldehydes, and preferably is an aliphatic aldehyde.

For example, aliphatic aldehydes such as formaldehyde, acetaldehyde, propionaldehyde, butyraldehyde, heptaldehyde, hexaldehyde, crotonaldehyde, cinnamic aldehyde, hydrocinnamic aldehyde and 2-phenylpropionaldehyde can be used effectively in preparing the condensation products disclosed herein. For general purposes, the applicable aldehydes can be represented by the formula R¹CHO wherein R¹ is a hydrocarbon group containing up to about 12 carbon atoms.

The amine used in the amine-aldehyde condensation product may be primary or secondary amine, and may be selected from the group consisting of aliphatic amines and aromatic amines.

For example, primary aliphatic amines such as ethyl, n-butyl, n-propyl, isopropyl, n-hexyl and t-butyl amines conveniently can be used. Also primary aromatic amines, such as aniline, p-toluidine, o- or p-naphthalamine, xylidene, benzylamine or p-benzylaniline can be used. While the primary amines are preferred amines for use in preparing the condensation products disclosed herein, aliphatic or aromatic secondary amines also can be used. Typical examples of acceptable secondary amines are diethylamine, dipropylamine, diisopropylamine, diphenylamine, N-phenyl benzylamine and N-allylaniline. For general purposes, the applicable amines can be represented by the formula R²R³NH, wherein R² is a hydrocarbon radical containing up to about 14 carbon atoms, and R³ is either hydrogen or R².

Typical examples of amine-aldehyde condensation compounds which are useful in the invention disclosed herein are the following: formaldehyde-p-benzyl aniline; acetaldehyde-benzylamine; crotonaldehyde-butylamine; cinnamic aldehyde-aniline; cinnamic aldehyde-butylamine; 2-phenylpropionaldehyde-butylamine; butyraldehyde-butylamine; butyraldehyde-aniline; hydrocinnamaldehyde-butylamine; naphthaldehyde-o-toluidine; and heptaldehyde-N-allylaniline. Preferably, the amine-aldehyde condensation compound is a butyraldehyde-aniline condensation compound, preferably PDHP (3,5-Diethyl-1,2-Dihydro-1-Phenyl-2-Propylpyridine).

A commercial example of such an amine-aldehyde condensation compound is REILLY PDHP™ from Reilly Industries, Inc. of Indianapolis, Ind. The REILLY PDHP™ is a mixture in which the active ingredient is believed to be n-phenyl-2-propyl-3,5-diethyl-1,2-dihydropyridine having the chemical formula C₁₅H25N and structure depicted below:

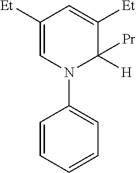

Preferably, the content of the amine-aldehyde condensation compound is 0.3 to 3.5 wt. %, based on the total weight of the first part. More preferably, the content of the amine-aldehyde condensation compound is 0.75 to 2.0 wt. %, based on the total weight of the first part. If said content is higher than 3.5 wt. %, the bonding strength tend to become poor. If said content is lower than 0.3 wt. %, the curing speed tends to become low, and the bonding property tends to become poor.

### Organic Transitional Metal Compound

In the present invention, organic transitional metal compound refers to any transition metal-containing organic compound. The transitional metals are the metals of Group IB, IIIA, IIIB, IVA, VA, VI, VII, VIIA of the Periodic Table of the Elements. Advantageous transitional metals include copper, chromium, manganese, iron, cobalt, nickel, molybdenum and vanadium. Preferably, the transitional metal is selected from copper and vanadium.

The organic transitional metal compounds include oxides, salts, and organometallic chelates and complexes. Suitable organic salts include the alkoxide, for example, the methoxides and ethoxides, as well as the carboxylates, including the acetates, hexoates, octoates, ethylhexanoates, and naphthenates. Other suitable transitional metal complexes include the acetylacetonates and the hexafluoroacetylacetonates. Preferably, the organic transitional metal compound is selected from acetylacetonates and hexafluoroacetylacetonates.

In a preferred embodiment, the organic transitional metal compound is selected from copper complex compounds and vanadium complex compound. More preferably, the organic transitional metal compound is a vanadium complex compound.

The copper complex compound preferably contains at least one organic ligand represented by the following general formula (1) which is coordinatively bounded to a copper atom in the copper complex compound,

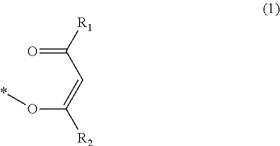

wherein * represents a coordinating position of the copper atom in the copper complex compound. R₁ and R₂ are identical or different, and independently represent optionally substituted univalent hydrocarbon groups. Preferably, R₁ and R₂ are optionally substituted C₁ to C₂₀ alkyl groups, alkenyl groups, or alkoxyl groups. More preferably, R₁ and R₂ are optionally substituted C₁ to C₈ alkyl groups, alkenyl groups or alkoxyl groups.

Example of commercially available copper complex compound is, for example, Copper (II) acetylacetonate from Sinopharm.

The vanadium complex compound preferably contains at least one organic ligand represented by the following general formula (2) which is coordinatively bounded to a vanadium atom in the vanadium complex compound,

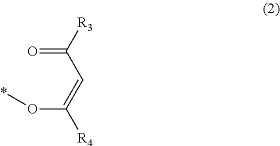

wherein * represents a coordinating position of the vanadium atom in the vanadium complex compound. R₃ and R₄ are identical or different, and independently represent optionally substituted univalent hydrocarbon groups. Preferably, R₃ and R₄ are optionally substituted C₁ to C₂₀ alkyl groups, alkenyl groups, or alkoxyl groups. More preferably, R₃ and R₄ are optionally substituted C₁ to C₈ alkyl groups, alkenyl groups or alkoxyl groups.

Examples of commercially available vanadium complex compounds are, for example, vanadyl (IV) acetylacetonate and Vanadium (Ill) acetylacetonate from Sinopharm.

In a preferred embodiment of the present invention, the organic transitional metal compound is vanadyl(IV)-acetylacetonate.

Preferably, the content of the organic transitional metal compound is 0.03 to 0.4 wt. %, based on the total weight of the second part. More preferably, the content of the organic transitional metal compound is 0.075 to 0.2 wt. %, based on the total weight of the second part. If said content is higher than 0.4 wt. %, the curing rate tends to become small, which corresponds to low peak exothermic temperature, and an unreacted component will remain and lead to poor bonding property. If said content is lower than 0.03 wt. %, the curing speed tends to become low.

### Phosphorus-Containing Compound

In the present invention, phosphorus-containing compound refers to any phosphorus-containing compound which is suitable for use as an accelerator in a structural adhesive system. Preferably, the phosphorus-containing compound is selected from the group consisting of phosphoric acid and organic derivatives of phosphinic acid, phosphonic acid and phosphoric acid, said organic derivatives having at least one organic moiety characterized by the presence of at least one functional group, preferably terminally located. Such organic derivatives can be saturated or unsaturated, and preferably have at least one organic moiety characterized by the presence of at least one unit of olefinic unsaturation. More particularly, such phosphorus-containing compounds have the characteristic formulae

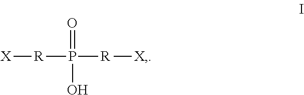

wherein each R is the same or different, and each R is independently a divalent organic radical directly bonded to the phosphorus atom through a carbon-phosphorus bond, said divalent radical being selected from the group consisting of divalent unsubstituted organic radical and divalent organic radical having at least one substituent group selected from the class consisting of halogen, hydroxyl, amino, alkyl radical containing from 1 to 8, preferably 1 to 4, carbon atoms and aryl radical having at least one moiety containing at least one aromatic nucleus; and wherein each X is the same or different, and each X is independently a functional group selected from the class consisting of hydrogen, hydroxyl, amino, mercapto, halogen and CH₂═C<

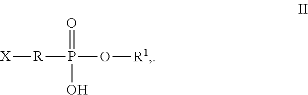

wherein R and X are as previously defined; and R¹ is hydrogen or —R²—X, wherein R² is a divalent organic radical directly bonded to the oxygen radical through a carbon-oxygen bond, said divalent radical R² being selected from the group consisting of divalent unsubstituted organic radical and divalent organic radical having at least one substituent group selected from the class consisting of halogen, hydroxyl, amino, alkyl radical containing from 1 to 8, preferably 1 to 4, carbon atoms and aryl radical having at least one moiety containing at least one aromatic nucleus and X is as previously defined; and

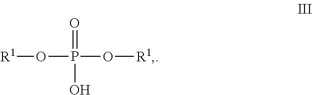

wherein R¹ is as previously described.

A currently preferred group of phosphorus-containing compound has the formula

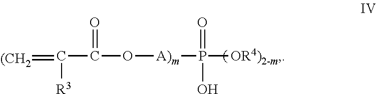

wherein R³ is selected from the group consisting of hydrogen, halogen, an alkyl group having from one to 8, preferably one to 4, carbon atoms, and CH₂═CH—; R⁴ is selected from the group consisting of hydrogen, an alkyl group having from one to 8, preferably one to 4 carbon atoms, and a haloalkyl group having one to 8, preferably one to 4, carbon atoms; A is selected from the group consisting of —R⁵O— and [symbol] R⁶O [symbol] ₙ, wherein R⁵ is an aliphatic or cycloaliphatic alkylene group containing from one to 9, preferably 2 to 6, carbon atoms; R⁶ is an alkylene group having from one to 7, preferably 2 to 4, carbon atoms; n is an integer from 2 to 10, and m is one to 2, preferably one.

In the several formulae I-IV, the divalent organic radicals R and R² can have a compound structure, that is, the radical can contain at least one, or a series of at least two, unsubstituted or substituted hydrocarbon group(s) containing or separated from each other by —O—, —S—, —COO—, —NH—, —NHCOO—, and [symbol] R⁷O [symbol] ₚ, wherein R⁷ is an alkylene group containing from 2 to 7, preferably 2 to 4 carbon atoms, and p is an integer from 2 to 10. Preferably, the divalent radical is an alkylene radical having a straight chain or ring of from one to 22, preferably one to 9, carbon atoms in any non-repeating unit. It will be understood that divalent radicals having a compound structure would have two or more of such straight chains or rings. The divalent radicals can be saturated or unsaturated; aliphatic, cycloaliphatic or aromatic; and, with compound structures, can include mixtures thereof; and generally have from 1 to about 22 carbon atoms in each chain or ring of carbon atoms.

In the several formulae I-Ill, representative X—R— and X—R²— radicals include, without limitation thereto, lower alkenyl, cyclohexenyl, hydroxyl-lower alkenyl, halo-lower alkenyl, carboxy-lower alkenyl, lower alkyl, amino-lower alkyl, hydroxyl-lower alkyl, mercapto-lower alkyl, alkoxy-lower alkyl, halo-lower alkyl, di-phosphonomethyl-amino-lower alkyl, phenyl-hydroxy-phosphonomethyl, aminophenyl-hydroxy-phosphonomethyl, halophenyl-hydroxy-phosphonomethyl, phenyl-amino-phosphonomethyl, halophenyl-amino-phosphonomethyl, hydroxyl-phosphonomethyl, lower alkyl-hydroxy-phosphonomethyl, halo-lower alkyl-hydroxy-phosphonomethyl and amino-lower alkyl-hydroxy-phosphonomethyl; the term “lower” referring to a group containing from 1 to 8, preferably 1 to 4 carbon atoms.

Phosphorus-containing compounds having vinyl unsaturation are preferred over such compounds having allylic unsaturation, with monoesters of phosphinic, phosphonic and phosphoric acids having one unit of vinyl or allylic, especially vinyl, unsaturation presently being preferred. Representative phosphorus-containing compounds include, without limitation, phosphoric acid; 2-methyacryloyl oxyethyl phosphate; bis-(2-methacryloyloxyethyl)phosphate; 2-acryloyloxyethyl phosphate; bis-(2-acryloyloxyethyl)phosphate; methyl-(2-methacryloyloxymethyl) phosphate; ethyl methacryloyloxyethyl phosphate; methyl acryloyloxyethyl phosphate; ethyl acryloyloxyethyl phosphate; compounds of Formula IV wherein R³ is hydrogen or methyl and R⁴ is propyl, isobutyl, ethylhexyl, halopropyl, haloisobutyl or haloethylhexyl; vinyl phoshonic acid; cyclohexene-3-phosphonic acid; alphalhydroxybutene-2-phosphonic acid; 1-hydroxy-1-phenylmethane-1,1-diphosphonic acid; 1-hydroxy-1-methyl-1-1-diphosphonic acid; 1-amino-1-phenyl-1,1-diphosphonic acid; 3-amino-1-hydroxypropane-1,1-diphosphonic acid; amino-tris(methylenephosphonic acid); gamma-amino-propylphosphonic acid; gamma-glycidoxypropylphosphonic acid; phosphoric acid-mono-2-aminoethyl ester; allyl phosphonic acid; allyl phosphinic acid; β-methacryloyloxyethyl phosphinic acid; diallylphosphonic acid; bis(β-methacryloyloxyethyl)phosphinic acid and allyl methacryloyloxyethyl phosphinic acid.

In a preferred embodiment of the present invention, the phosphorus-containing compound is selected from the group consisting of an organic phosphorus-containing compound and an inorganic phosphorus-containing compound, and preferably is an organic phosphorus-containing compound.

In a more preferred embodiment of the present invention, the phosphorus-containing compound is a phosphate, and preferably is selected from the group consisting of bis(2-hydroxylethyl methacrylate phosphate) and phosphate ester of 2-hydroxyethyl methacrylate.

The content of the phosphorus-containing compound is 0.2 to 4 wt. %, based on the total weight of the second part. Preferably, the content of the phosphorus-containing compound is 0.75 to 2.5 wt. %, based on the total weight of the second part.

If said content is higher than 4 wt. %, the curing speed tends to become low, and the bonding property tends to become poor. If said content is lower than 0.2 wt. %, the curing rate tends to become small, which corresponds to low peak exothermic temperature, and the bonding property also tends to become poor.

### (Meth)Acrylate Monomer Containing at Least One Hydroxyl Group Per Molecule

According to the present invention, the (meth)acrylate-based two-part adhesive composition comprises at least one (meth)acrylate monomer. The at least one (meth)acrylate monomer is included in the first part and/or the second part of the adhesive composition.

In the present invention, the (meth)acrylate monomer containing at least one hydroxyl group per molecule refers to a polymerisable (meth)acrylate ester monomer material containing at least one hydroxyl group per molecule. The polymerisable (meth)acrylate ester monomer material containing at least one hydroxyl group per molecule for use in the adhesive composition of the present invention may comprise one or more polymerisable (meth)acrylate ester monomers containing at least one hydroxyl group per molecule which may be admixed to form a homogeneous blend of monomeric material. Polymerisable (meth)acrylate ester monomers containing at least one hydroxyl group per molecule which may be employed include mono-, di- and poly-functional acrylates and methacrylates containing at least one hydroxyl group per molecule and mixtures thereof, the methacrylates containing at least one hydroxyl group per molecule being generally preferred. Suitable (meth)acrylate containing at least one hydroxyl group per molecule include: the well-known mono-(meth)acrylate esters containing at least one hydroxyl group per molecule, for example hydroxyethyl (meth)acrylate, and hydroxypropyl (meth)acrylate. Preferably, the (meth)acrylate monomer containing at least one hydroxyl group per molecule is selected from the group consisting of hydroxyethyl methacrylate and hydroxypropyl methacrylate, and more preferably, is hydroxypropyl methacrylate.

In a preferred embodiment of the present invention, the (meth)acrylate monomer containing at least one hydroxyl group per molecule may have the following general formula

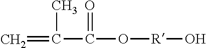

in which R′ is an ethylene, propylene or isopropylene group.

### (Meth)Acrylic Resin

According to the present invention, the (meth)acrylate-based two-part adhesive composition may comprise at least one (meth)acrylic resin. The at least one (meth)acrylic resin may be included in the first part and/or the second part of the adhesive composition.

The (meth)acrylic resin may be obtained by the polymerization of one or more (meth)acrylic monomers, optionally in combination with a non-(meth)acrylic monomer. Exemplary (meth)acrylic oligomers include poly(methyl methacrylate), poly(ethyl methacrylate), poly(methyl methacrylate/n-butylacrylate/ethyl acrylate), poly(n-butyl methacrylate/isobutyl methacrylate), poly(n-butyl methacrylate), poly(ethyl methacrylate), and combinations thereof.

Example of commercially available (meth)acrylic resins are, for example, CN 959 which is available from Sartomer, BR-202 DYMA which is available from DYMAX, BR-571 MB which is available from DYMAX, and SS-194 which is available from Henkel.

### Toughening Agent

According to the present invention, the (meth)acrylate-based two-part adhesive composition may comprise at least one toughening agent. The at least one toughening agent may be included in the first part and/or the second part of the adhesive composition.

The toughening agent can be any one which is conventionally used in a (meth)acrylate-based two-part adhesive composition. Examples of some useful toughening agent include elastomeric rubbers; elastomeric polymers; liquid elastomer; polyesters; acrylic rubbers; butadiene/acrylonitrile rubber; Buna rubber; polyisobutylene; polyisoprene; natural rubber; synthetic rubber such as styrene/butadiene rubber (SBR); polyurethane polymers; ethylene-vinyl acetate polymers; fluorinated rubbers; isoprene-acrylonitrile polymers; chlorosulfonated polyethylenes; homopolymers of polyvinyl acetate; block copolymers; core-shell rubber particles, and mixtures thereof. Preferably, the toughening agent is a rubber toughening agent.

An example of commercially available toughening agent is Nipol 1072 CGX, which is available from ZEON.

### Inhibitor

According to the present invention, the (meth)acrylate-based two-part adhesive composition may comprise at least one inhibitor. The at least one inhibitor may be included in the first part and/or the second part of the adhesive composition.

The inhibitor, which can facilitate the storage stability of (meth)acrylate-based adhesive compositions, may be any common acid polymerization inhibitor and free radical inhibitor known in the art. Exemplary of the inhibitor includes but are not limited to sulfur dioxide, glacial acetic acid, hydroquinone, 2-methylhydroquinone, 2-t-butylhydroquinone, t-butyl catechol, butylated hydroxy toluene, 4-methoxyphenol, 2,6-di-tertbutylphenol, and the like.

Examples of commercially available inhibitors are, for example, butylated hydroxytoluene (BHT) and 4-methoxyphenol (MeHQ) from Sinopharm.

### Optional Additives

In the present invention, the (meth)acrylate-based two-part adhesive composition of the present invention may further comprise one or more additives besides those described above. In particular, the additive which may be used in the (meth)acrylate-based two-part adhesive composition of the present invention is any additive which is conventionally used in a (meth)acrylate-based two-part adhesive composition, as long as it does not negatively affect the effect of the (meth)acrylate-based two-part adhesive composition of the present invention. Examples of the additives include but are not limited to crosslinkers, reinforcers, fillers, pigments, thickeners, solvents, and the mixtures thereof.

In a preferred embodiment, the (meth)acrylate-based two-part adhesive composition of the present invention comprises:
a first part, comprising:
at least one (meth)acrylate monomer containing at least one hydroxyl group per molecule,
at least one (meth)acrylic resin,
at least one toughening agent,
at least one inhibitor, and
at least one amine-aldehyde condensation compound; and
a second part, comprising:
at least one (meth)acrylate monomer containing at least one hydroxyl group per molecule,
at least one (meth)acrylic resin,
at least one toughening agent,
at least one inhibitor,
at least one organic transitional metal compound, and
at least one phosphorus-containing compound.

In a more preferred embodiment, the (meth)acrylate-based two-part adhesive composition of the present invention comprises:
a first part, based on the total weight of the first part, comprising:
from 30.0 to 90.0 wt %, preferably 40.0 to 80.0 wt. %, more preferably 55.0 to 75.0 wt. %, of at least one (meth)acrylate monomer containing at least one hydroxyl group per molecule,
from 5 to 40.0 wt %, preferably 10.0 to 30.0 wt. %, more preferably 15.0 to 25.0 wt. %, of at least one (meth)acrylic resin,
from 5 to 30.0 wt %, preferably 5.0 to 20.0 wt. %, more preferably 9 wt. % to 15 wt. %, of at least one toughening agent,
from 0.05 to 0.5 wt %, preferably 0.075 to 0.2 wt. %, of at least one inhibitor, and
from 0.3 to 3.5 wt %, preferably 0.75 to 2.0 wt. %, of at least one amine-aldehyde condensation compound; and
a second part, based on the total weight of the second part, comprising:
from 30.0 to 90.0 wt %, preferably 40.0 to 80.0 wt. %, more preferably 55.0 to 75.0 wt. %, of at least one (meth)acrylate monomer containing at least one hydroxyl group per molecule,
from 5 to 40.0 wt %, preferably 10.0 to 30.0 wt. %, more preferably 15.0 to 25.0 wt. %, of at least one (meth)acrylic resin,
from 5 to 30.0 wt %, preferably 5.0 to 20.0 wt. %, more preferably 9 wt. % to 15 wt. %, of at least one toughening agent,
from 0.05 to 0.5 wt %, preferably 0.075 to 0.2 wt. %, of at least one inhibitor,
from 0.03 to 0.4 wt %, preferably 0.075 to 0.2 wt. %, of at least one organic transitional metal compound, and
from 0.2 to 4 wt %, preferably 0.75 to 2.5 wt. %, of at least one phosphorus-containing compound.

As is known in the art, the first part and the second part in the (meth)acrylate-based two-part adhesive composition of the present invention are separately prepared and stored before use. The ratio by weight of the first part: the second part is 5:1 to 1:5, preferably 2:1 to 1:2, more preferably 1.5:1 to 1:1.5, most preferably 1.2:1 to 1:1.2. In a further preferred embodiment, the ratio by weight of the first part: the second part is 1:1:1 to 1:1.1, more preferably 1:1.05 to 1.05:1.

The (meth)acrylate-based two-part adhesive composition of the present invention may be prepared by the steps of:
a) providing at least one amine-aldehyde condensation compound;
b) optionally adding at least one (meth)acrylate monomer containing at least one hydroxyl group per molecule, and/or at least one toughening agent, and/or at least one (meth)acrylic resin, and/or at least one inhibitor, and/or other optional additives; and mixing all the components homogeneously to obtain the first part;
c) mixing at least one organic transitional metal compound with at least one phosphorus-containing compound; and
d) optionally adding at least one (meth)acrylate monomer containing at least one hydroxyl group per molecule, and/or at least one toughening agent, and/or at least one (meth)acrylic resin, and/or at least one inhibitor, and/or other optional additives and mixing all the components homogeneously to obtain the second part.

The first part and the second part may be stored separately in different chambers of a mixing equipment and should be mixed prior to the use of the (meth)acrylate-based two-part adhesive composition. The adhesive composition of the present invention can be well cured at ambient temperature (i.e. 25° C.±2° C.). Additionally, increased curing temperature will increase the bonding strength of the (meth)acrylate-based two-part adhesive.

In the present invention, heating can be carried out by any device which can be used for curing the (meth)acrylate-based two-part adhesive, especially a standard oven/chamber or other equipment with a temperature controller system for the specified temperature soaking of the test specimen. The (meth)acrylate-based two-part adhesive composition according to the present invention shows a high bonding strength on metal substrate when curing at room temperature, and a significantly increased bonding strength when curing at elevated temperature. Preferably, the elevated temperature is from 80° C. to 130° C. More preferably, the elevated temperature is from 100° C. to 110° C. If said elevated temperature is lower than 80° C., there is no significant increase in bonding strength or need more time to achieve the same effects in bonding strength improvement. If said elevated temperature is higher than 130° C., bonding strength tends to become poor due to the effect of high temperature aging.

In a preferred embodiment of the method of the present invention, the first substrate and the second substrate are identical or different materials selected from the group consisting of metals, plastics, ceramic, glass and cellulosic materials, and preferably are selected from the group consisting of loudspeaker components and coils.

Furthermore, the present invention provides an article bonded by the (meth)acrylate-based two-part adhesive composition according to the present invention, or obtained by the method according to the present invention.

### Examples

The present invention will be further described and illustrated in detail with reference to the following examples. The examples are intended to assist one skilled in the art to better understand and practice the present invention, however, are not intended to restrict the scope of the present invention. All the amounts in the examples are based on weight in grams unless otherwise stated.

### Materials

The following materials were employed in the Examples:

| | Abbreviation and/or | | |
|---|---|---|---|
| Type | Trade Name | Name and/or Description | Manufacturer |
| (Meth)acrylate | HEMA | 2-hydroxypropyl methacrylate | GEO Specialty |
| monomer | | | Chemicals |
| | HPMA | 2-hydroxyethyl methacrylate | GEO Specialty |
| | | | Chemicals |
| | THFMA | Tetrahydrofurfuryl | SARTOMER |
| | | methacrylate | |
| | MMA | Methyl methacrylate | Sinopharm Chemical |
| | | | Reagent Co. |
| Toughening | Nipol 1072CGX | Butadiene, acrylonitrile, | Zeon |
| agent | | methacrylic acid copolymer | |
| Inhibitor | MeHQ | 4-Methoxyphenol | Sinopharm Chemical |
| | | | Reagent Co. |
| Amine-aldehyde | Reilly PDHP ™ | (3,5-Diethyl-1,2-Dihydro-1- | Reilly |
| condensation | | Phenyl-2-Propylpyridine | |
| compound | | | |
| Phosphorus- | Phosphate, PM-2 | bis(2-Hydroxylethyl | Kyoeisha Chemicals |
| containing | | methacrylate phosphate) | |
| compound | Harcryl 1228, PM-1 | Phosphate Ester of 2- | Harcros Chemicals Inc |
| | | hydroxyethyl Methacrylate | |
| | H₃PO₄ | Phosphoric acid | Sinopharm Chemical |
| | | | Reagent Co. |
| (Meth)acrylic | CN 959 | aliphatic urethane oligomer | Sartomer |
| resins | BR-202 | aliphatic urethane oligomer | Dymax |
| | BR-571MB | aliphatic urethane oligomer | Dymax |
| | SS-194 | aliphatic urethane oligomer | Henkel |
| Organic | | Vanadyl acetylacetonate (cas | Sinopharm Chemical |
| transitional | | no. 3153-26-2), VO(acac)₂ | Reagent Co. |
| metal | | Manganese(III) | Sinopharm Chemical |
| compound | | acetylacetonate (cas | Reagent Co. |
| | | no. 14284-89-0) | |
| | | Copper(II) acetylacetonate | Sinopharm Chemical |
| | | (cas no. 13395-16-9) | Reagent Co. |
| Reducing agent | | α-acetyl-γ-butyrolactone | Sinopharm Chemical |
| | | | Reagent Co. |
| | | ethyl acetoacetate | Sinopharm Chemical |
| | | | Reagent Co. |
| | ETU | Ethylenethiourea | Sinopharm Chemical |
| | | | Reagent Co. |
| | DMT | Dimethyl-p-toluidine | Sinopharm Chemical |
| | | | Reagent Co. |
| | THQ | tetrahydroquinoline | Sinopharm |
| | | | Chemical Reagent |
| | | | Co. |
| | MAA | Methacrylic acid | Sinopharm |
| | | | Chemical Reagent |
| | | | Co. |

### Preparation of Two-Part Adhesive Compositions

The two-part adhesive compositions of Examples (Ex.) were prepared by mixing all the materials in a first part in the amounts listed in the following tables to obtain the first part, mixing all the materials in a second part in the amounts listed in the following tables to obtain the second part, and then mixing the first part with the second part before use.

### Test Methods

The properties of the two-part adhesive compositions of Examples were measured as follows.

### Peak Exothermic Temperature & Peak Exothermic Time

Test was performed in a controlled atmosphere of 25° C.±2° C. and 50±5% RH. Sample was stabilized at 25° C. prior to the test. A 1:1 Sulzer mixpac mixer was used to mix the first part and the second part of the two-part adhesive composition together. The exothermic temperature at various dwell time of the mixture of the two-part adhesive composition was automatically recorded by a thermocouple. The peak exothermic temperature of the two-part adhesive composition was measured according to ASTM D2471 Standard Test Method for Gel Time and Peak Exothermic Temperature of Reacting Thermosetting Resins. The detailed procedures were slightly modified as the following steps:
(a) extruding a small amount of the two-part adhesive composition with no static mixer attached to the 1:1 Sulzer mixpac mixer to ensure the first part and the second part were being dispensed from both sides of the 1:1 Sulzer mixpac mixer;
(b) placing a 100 ml disposable plastic beaker in a heat insulation container;
(c) attaching a static mixer matching the 1:1 Sulzer mixpac mixer to the 1:1 Sulzer mixpac mixer and extruding 15 grams of the mixture of the two-part adhesive composition into the beaker;
(d) inserting a probe of a thermocouple into the center of the beaker immediately and programing the thermocouple to record temperature output versus time at a time interval of one second;
(e) removing the probe from the beaker after the temperature reached a peak value and then decreased about 10° C.

Suitable peak exothermic time of a two-part adhesive composition should be no longer than 2000 seconds.

### Gel Time

Gel time of the two-part adhesive composition was determined by the time at which exothermic temperature in tests of “Peak Exothermic Temperature & Peak Exothermic Time” reach 30° C., when the mixed adhesive composition shows an obvious increase in viscosity and is difficult to dispense.

### Lap-Shear Strength

Lap-shear strength of the two-part adhesive composition was measured according to ASTM D1002 Standard Test Method for Apparent Shear Strength of Single-Lap-Joint Adhesively Bonded Metal Specimens by Tension Loading (Metal-to-Metal).

Suitable lap-shear strength of a two-part adhesive composition on mild-steel substrates after curing for 24 hours at room temperature (i.e. 25° C.) should be higher than 1 N/mm², and suitable lap-shear strength of a two-part adhesive composition on mild-steel substrates after curing for 24 hours at room temperature and then curing for 3 hours at 100° C. should be higher than 5 N/mm².

The test results of the two-part adhesive compositions are also shown in the following tables.

TABLE 1
Effect of (meth)acrylate monomer on gel time, peak
exothermic temperature, peak exothermic time and bonding
strength of the two-part adhesive composition

| Amounts (units: in grams) | | Ex. 1 | Ex. 2 | Ex. 3 | Ex. 4 |
|---|---|---|---|---|---|
| First part | HEMA | 66 | | | |
| | HPMA | | 66 | | |
| | THFMA | | | 66 | |
| | MMA | | | | 66 |
| | Nipol 1072CGX | 12 | 12 | 12 | 12 |
| | BR-571MB | 20 | 20 | 20 | 20 |
| | MeHQ | 0.1 | 0.1 | 0.1 | 0.1 |
| | Reilly PDHP ™ | 1 | 1 | 1 | 1 |
| Second part | HEMA | 66 | | | |
| | HPMA | | 66 | | |
| | THFMA | | | 66 | |
| | MMA | | | | 66 |
| | Nipol 1072CGX | 12 | 12 | 12 | 12 |
| | BR-571MB | 20 | 20 | 20 | 20 |
| | MeHQ | 0.1 | 0.1 | 0.1 | 0.1 |
| | Vanadyl | 0.1 | 0.1 | 0.1 | 0.1 |
| | acetylacetonate | | | | |
| | Phosphate, PM-2 | 2 | 2 | 2 | 2 |

Property evaluation

| | | | | | |
|---|---|---|---|---|---|
| Testing by | Gel time | 150 | 751 | 2306 | NM* |
| thermocouple | (in seconds) | | | | |
| | Peak exothermic | 96.4 | 63.8 | 33 | 26.5 |
| | temperature | | | | |
| | (in ° C.) | | | | |
| | Peak exothermic | 304 | 1550 | 3215 | 4456 |
| | Time | | | | |
| | (in seconds) | | | | |
| Lap-shear | 24 HRTC** | 16.0 | 10.3 | 0.6 | NM* |
| strength on mild- | 24 HRTC + 3 | 24.4 | 19.9 | 2.2 | NM* |
| steel substrates | hours@100° | | | | |
| (in N/mm²) | C. *** | | | | |

Note:
NM* refers to no measurement, since evaluation of the properties was impossible; 24 HRTC** refers to curing for 24 hours at room temperature (i.e. 25° C.); and 24 HRTC + 3 hours@100° C. *** refers to curing for 24 hours at room temperature and then curing for 3 hours at 100° C.

As illustrated by Examples 1 and 2 in Table 1, by using a (meth)acrylate monomer containing at least one hydroxyl group per molecule, the two-part adhesive composition according to the present invention exhibited short gel time and peak exothermic time, and high peak exothermic temperature, which correspond to fast curing speed and high curing rate, respectively, and thus are desirable; and the two-part adhesive composition according to the present invention also showed good bonding strength under both 24H RTC and 24HRTC+3 hours@100° C.

In contrast, as illustrated by Examples 3 and 4, if the (meth)acrylate monomer does not contain any hydroxyl group, the two-part adhesive composition neither exhibited short gel time and peak exothermic time and high exothermic temperature, nor showed good bonding strength under both 24HRTC and 24HRTC+3 hours@100° C.

TABLE 2
Effect of (meth)acrylic resin on peak exothermic time and
bonding strength of the two-part adhesive composition

| Amounts (units: in grams) | | Ex. 5 | Ex. 6 | Ex. 1 | Ex. 7 |
|---|---|---|---|---|---|
| First part | CN959 | 20 | | | |
| | BR-202 | | 20 | | |
| | BR-571MB | | | 20 | |
| | SS-194 | | | | 20 |
| | Nipol 1072CGX | 12 | 12 | 12 | 12 |
| | HEMA | 66 | 66 | 66 | 66 |
| | MeHQ | 0.1 | 0.1 | 0.1 | 0.1 |
| | Reilly PDHP ™ | 1 | 1 | 1 | 1 |
| Second part | CN 959 | 20 | | | |
| | BR-202 | | 20 | | |
| | BR-571 | | | 20 | |
| | SS-194 | | | | 20 |
| | Nipol 1072CGX | 12 | 12 | 12 | 12 |
| | HEMA | 66 | 66 | 66 | 66 |
| | MeHQ | 0.1 | 0.1 | 0.1 | 0.1 |
| | Vanadyl | 0.1 | 0.1 | 0.1 | 0.1 |
| | acetylacetonate | | | | |
| | Phosphate, PM-2 | 2 | 2 | 2 | 2 |

Property evaluation

| | | | | | |
|---|---|---|---|---|---|
| Testing by | Peak exothermic | 516 | 328 | 304 | 525 |
| thermocouple | Time (in seconds) | | | | |
| Lap-shear | 24 HRTC** | 3.7 | 13.9 | 16.0 | 12.2 |
| strength on mild- | 24 HRTC + 3 | 18.3 | 16.5 | 24.4 | 26.0 |
| steel substrates | hours@100° C. *** | | | | |
| (in N/mm²) | | | | | |

Note:
24 HRTC** refers to curing for 24 hours at room temperature (i.e. 25° C.); and 24 HRTC + 3 hours@100° C.*** refers to curing for 24 hours at room temperature (i.e. 25° C.) and then curing for 3 hours at 100° C.

As shown in Table 2, by using various (meth)acrylic resins, the two-part adhesive composition according to the present invention exhibited short gel time and peak exothermic time, and high peak exothermic temperature, which correspond to fast curing speed and high curing rate, respectively, and thus are desirable; and the two-part adhesive composition according to the present invention also showed good bonding strength under both 24H RTC and 24HRTC+3 hours@100° C. In addition, the test results in Table 2 showed that the two-part adhesive composition according to the present invention cured under elevated temperature showed much higher bonding strength than that cured at room temperature.

TABLE 3
Effect of the content of amine-aldehyde condensation
compound on peak exothermic time and bonding strength
of the two-part adhesive composition

| Amounts (units: in grams) | | Ex. 8 | Ex. 9 | Ex. 10 |
|---|---|---|---|---|
| First part | HEMA | 66 | 66 | 66 |
| | Nipol 1072CGX | 12 | 12 | 12 |
| | BR-571MB | 20 | 20 | 20 |
| | MeHQ | 0.1 | 0.1 | 0.1 |
| | Reilly PDHP ™ | 0.5 | 1 | 3 |
| Second part | HEMA | 66 | 66 | 66 |
| | Nipol 1072CGX | 12 | 12 | 12 |
| | BR-571MB | 20 | 20 | 20 |
| | MeHQ | 0.1 | 0.1 | 0.1 |
| | Vanadyl | 0.2 | 0.2 | 0.2 |
| | acetylacetonate | | | |
| | Phosphate, PM-2 | 2 | 2 | 2 |

Property evaluation

| | | | | |
|---|---|---|---|---|
| Testing by thermocouple | Peak exothermic | 417 | 305 | 324 |
| | Time (in seconds) | | | |
| Lap-shear strength on | 24 HRTC** | 14.9 | 19.0 | 12.2 |
| mild-steel substrates | 24 HRTC + | 19.2 | 28.3 | 24.7 |
| (in N/mm²) | 3 hours@100° C.*** | | | |

Note:
NM* refers to no measurement, since evaluation of the properties was impossible; 24 HRTC** refers to curing for 24 hours at room temperature (i.e. 25° C.); and 24 HRTC + 3 hours@100° C.*** refers to curing for 24 hours at room temperature and then curing for 3 hours at 100° C.

As illustrated in Table 3, by using an amine-aldehyde condensation compound, especially 0.3 to 3.5 wt. % of an amine-aldehyde condensation compound based on the total weight of the first part, the two-part adhesive composition according to the present invention exhibited short peak exothermic time, which corresponds to fast curing speed, and thus is desirable; and the two-part adhesive composition according to the present invention also showed good bonding strength under both 24HRTC and 24HRTC+3 hours@100° C. In addition, as shown by Ex. 9, by using 0.75 to 2 wt. % of an amine-aldehyde condensation compound based on the total weight of the first part, the two-part adhesive composition according to the present invention exhibited shorter peak exothermic time and better bonding strength under both 24HRTC and 24HRTC+3 hours@100° C.

TABLE 4
Effect of the content of organic transitional metal compound
on bonding strength of the two-part adhesive compositions

| | | Ex. | Ex. | Ex. | Ex. |
|---|---|---|---|---|---|
| Amounts (units: in grams) | | 11 | 12 | 13 | 14 |
| First part | HEMA | 66 | 66 | 66 | 66 |
| | Nipol 1072CGX | 12 | 12 | 12 | 12 |
| | BR-571MB | 20 | 20 | 20 | 20 |
| | MeHQ | 0.1 | 0.1 | 0.1 | 0.1 |
| | Reilly PDHP ™ | 2 | 2 | 2 | 2 |
| Second part | HEMA | 66 | 66 | 66 | 66 |
| | Nipol 1072CGX | 12 | 12 | 12 | 12 |
| | BR-571MB | 20 | 20 | 20 | 20 |
| | MeHQ | 0.1 | 0.1 | 0.1 | 0.1 |
| | Vanadyl acetylacetonate | 0.05 | 0.1 | 0.3 | 0.5 |
| | Phosphate, PM-2 | 2 | 2 | 2 | 2 |

Property evaluation

| | | | | | |
|---|---|---|---|---|---|
| Lap-shear | 24 HRTC** | 7.5 | 11.8 | 7.7 | 3.7 |
| strength on mild- | 24 HRTC + | 22.7 | 24.1 | 19.4 | 12.4 |
| steel substrates | 3 hours@100° | | | | |
| (in N/mm²) | C.*** | | | | |

Note:
24 HRTC** refers to curing for 24 hours at room temperature (i.e. 25° C.); and 24 HRTC + 3 hours@100° C.*** refers to curing for 24 hours at room temperature and then curing for 3 hours at 100° C.

As illustrated in Table 4, by using an organic transitional metal compound, especially 0.03 to 0.4 wt. % of an organic transitional metal compound based on the total weight of the second part, the two-part adhesive composition according to the present invention showed good bonding strength under both 24HRTC and 24HRTC+3 hours@100° C. In addition, as shown by Ex. 12, by using 0.075 to 0.2 wt. % of an organic transitional metal compound based on the total weight of the second part, the two-part adhesive composition according to the present invention showed better bonding strength under both 24HRTC and 24HRTC+3 hours@100° C.

TABLE 5
Effect of the presence and content of phosphorus-containing compound on peak
exothermic time and bonding strength of the two-part adhesive composition

| Amounts (units: in grams) | | Ex. 15 | Ex. 16 | Ex. 17 | Ex. 18 | Ex. 19 |
|---|---|---|---|---|---|---|
| First part | HEMA | 66 | 66 | 66 | 66 | 66 |
| | Nipol 1072CGX | 12 | 12 | 12 | 12 | 12 |
| | BR-571MB | 20 | 20 | 20 | 20 | 20 |
| | MeHQ | 0.1 | 0.1 | 0.1 | 0.1 | 0.1 |
| | Reilly PDHP ™ | 1 | 1 | 1 | 1 | 1 |
| Second part | HEMA | 66 | 66 | 66 | 66 | 66 |
| | Nipol 1072CGX | 12 | 12 | 12 | 12 | 12 |
| | BR-571MB | 20 | 20 | 20 | 20 | 20 |
| | MeHQ | 0.1 | 0.1 | 0.1 | 0.1 | 0.1 |
| | Vanadyl | 0.1 | 0.1 | 0.1 | 0.1 | 0.1 |
| | acetylacetonate | | | | | |
| | Phosphate, PM-2 | 0 | 0.5 | 1 | 3 | 5 |

Property evaluation

| | | | | | | |
|---|---|---|---|---|---|---|
| Testing by | Peak exothermic | 619 | 468 | 404 | 615 | 1104 |
| thermocouple | Time (in seconds) | | | | | |
| Lap-shear strength on | 24HRTC** | 0.3 | 5.8 | 6.0 | 4.1 | 2.9 |
| mild-steel substrates | 24HRTC + 3 | 1.0 | 9.1 | 18.9 | 12.5 | 6.7 |
| (in N/mm²) | hours@100° C.*** | | | | | |

Note:
24HRTC** refers to curing for 24 hours at room temperature (i.e. 25° C.); and 24HRTC + 3 hours@100° C.*** refers to curing for 24 hours at room temperature and then curing for 3 hours at 100° C.

As illustrated in Table 5, by using a phosphorus-containing compound, especially 0.2 to 4 wt. % of an phosphorus-containing compound based on the total weight of the second part, the two-part adhesive composition according to the present invention exhibited short peak exothermic time and good bonding strength under both 24HRTC and 24HRTC+3 hours@100° C. In addition, as shown by Ex. 17, by using 0.075 to 2.5 wt. % of a phosphorus-containing compound based on the total weight of the second part, the two-part adhesive composition according to the present invention exhibited shorter peak exothermic time and better bonding strength under both 24HRTC and 24HRTC+3 hours@100° C.

TABLE 6
Effect of the type of organic transitional metal compound
on bonding strength of the two-part adhesive composition

| | | Ex. | Ex. | Ex. |
|---|---|---|---|---|
| Amounts (units: in grams) | | 20 | 21 | 22 |
| First part | HEMA | 66 | 66 | 66 |
| | Nipol 1072CGX | 12 | 12 | 12 |
| | SS-194 | 20 | 20 | 20 |
| | MeHQ | 0.1 | 0.1 | 0.1 |
| | Reilly PDHP ™ | 1 | 1 | 1 |
| Second part | HEMA | 66 | 66 | 66 |
| | Nipol 1072CGX | 12 | 12 | 12 |
| | SS-194 | 20 | 20 | 20 |
| | MeHQ | 0.1 | 0.1 | 0.1 |
| | Manganese(III) acetylacetonate | 0.2 | | |
| | Copper(II) acetylacetonate | | 0.2 | |
| | Vanadyl acetylacetonate | | | 0.2 |
| | Phosphate, PM-2 | 2 | 2 | 2 |

Property evaluation

| | | | | |
|---|---|---|---|---|
| Lap-shear | 24 HRTC** | 7.1 | 7.9 | 19.0 |
| strength on mild- | 24 HRTC + 3 | 6.7 | 16.9 | 28.3 |
| steel substrates | hours@100° C.*** | | | |
| (in N/mm²) | | | | |

Note:
24 HRTC** refers to curing for 24 hours at room temperature (i.e. 25° C.); and 24 HRTC + 3 hours@100° C.*** refers to curing for 24 hours at room temperature and then curing for 3 hours at 100° C.

As illustrated in Table 6, by using an organic transitional metal compound, the two-part adhesive composition according to the present invention exhibited good bonding strength under both 24H RTC and 24HRTC+3 hours@100° C. In addition, as shown by Ex. 21 and 22, by using vanadium and cuprous complexes, especially vanadium organic complex, more preferably vanadyl (IV)-acetylaceton ate, the two-part adhesive composition according to the present invention exhibited better bonding strength under both 24H RTC and 24HRTC+3 hours@100° C.

TABLE 7
Effect of the presence and type of phosphorus-containing
compound on peak exothermic time and bonding strength
of the two-part adhesive composition

| | | Ex. | Ex. | Ex. | Ex. |
|---|---|---|---|---|---|
| Amounts (units: in grams) | | 23 | 24 | 25 | 26 |
| First part | HEMA | 66 | 66 | 66 | 66 |
| | Nipol 1072CGX | 12 | 12 | 12 | 12 |
| | SS-194 | 20 | 20 | 20 | 20 |
| | MeHQ | 0.1 | 0.1 | 0.1 | 0.1 |
| | Reilly PDHP ™ | 1 | 1 | 1 | 1 |
| Second part | HEMA | 66 | 66 | 66 | 66 |
| | Nipol 1072CGX | 12 | 12 | 12 | 12 |
| | SS-194 | 20 | 20 | 20 | 20 |
| | MeHQ | 0.1 | 0.1 | 0.1 | 0.1 |
| | Vanadyl | 0.2 | 0.2 | 0.2 | 0.2 |
| | acetylacetonate | | | | |
| | Phosphate, PM-2 | 2 | | | |
| | Harcryl 1228, PM-1 | | 2 | | |
| | H₃PO₄ | | | 2 | |
| | MAA | | | | 2 |

Property evaluation

| | | | | | |
|---|---|---|---|---|---|
| Testing by | Peak exothermic | 305 | 481 | 602 | 954 |
| thermocouple | Time (in seconds) | | | | |
| Lap-shear strength | 24 HRTC** | 19.0 | 16.5 | 13.1 | NM* |
| on mild-steel | 24 HRTC + 3 | 28.3 | 21.8 | 20.0 | 1.2 |
| substrates | hours@100° C.*** | | | | |
| (in N/mm²) | | | | | |

Note:
NM* refers to no measurement, since evaluation of the properties was impossible; 24 HRTC** refers to curing for 24 hours at room temperature (i.e. 25° C.); and 24 HRTC + 3 hours@100° C.*** refers to curing for 24 hours at room temperature and then curing for 3 hours at 100° C.

As illustrated by Ex. 23-25 vs. Ex. 26 in Table 7, by using an phosphorus-containing compound, the two-part adhesive composition according to the present invention exhibited shorter peak exothermic time and better bonding strength under both 24H RTC and 24HRTC+3 hours@100° C. In addition, as shown by Ex. 23-24 vs. Ex. 26, by using an organic phosphorus-containing compound, especially phosphonate, the two-part adhesive composition according to the present invention exhibited shorter peak exothermic time and better bonding strength under both 24HRTC and 24HRTC+3 hours@100° C.

TABLE 8
Effect of the presence of amine-aldehyde condensation compound
on gel time, peak exothermic temperature, peak exothermic time
and bonding strength of the two-part adhesive composition

| Amounts (units: in grams) | | Ex. 27 | Ex. 28 | Ex. 29 | Ex. 30 | Ex. 31 | Ex. 32 |
|---|---|---|---|---|---|---|---|
| First part | HEMA | 66 | 66 | 66 | 66 | 66 | 66 |
| | Nipol 1072CGX | 12 | 12 | 12 | 12 | 12 | 12 |
| | SS-194 | 20 | 20 | 20 | 20 | 20 | 20 |
| | MeHQ | 0.1 | 0.1 | 0.1 | 0.1 | 0.1 | 0.1 |
| | Reilly PDHP ™ | 1 | | | | | |
| | α-acetyl-γ- | | 1 | | | | |
| | butyrolactone | | | | | | |
| | ethyl | | | 1 | | | |
| | acetoacetate | | | | | | |
| | ETU | | | | 1 | | |
| | DMT | | | | | 1 | |
| | THQ | | | | | | 1 |
| Second part | HEMA | 66 | 66 | 66 | 66 | 66 | 66 |
| | Nipol 1072CGX | 12 | 12 | 12 | 12 | 12 | 12 |
| | SS-194 | 20 | 20 | 20 | 20 | 20 | 20 |
| | MeHQ | 0.1 | 0.1 | 0.1 | 0.1 | 0.1 | 0.1 |
| | Vanadyl | 0.2 | 0.2 | 0.2 | 0.2 | 0.2 | 0.2 |
| | acetylacetonate | | | | | | |
| | Phosphate, PM- | 2 | 2 | 2 | 2 | 2 | 2 |
| | 2 | | | | | | |

Property evaluation

| | | | | | | | |
|---|---|---|---|---|---|---|---|
| Testing by | gel time | 97 | NM* | NM* | NM* | NM* | NM* |
| thermocouple | (in seconds) | | | | | | |
| | peak exothermic | 96.9 | NM* | NM* | NM* | NM* | NM* |
| | temperature | | | | | | |
| | (in ° C.) | | | | | | |
| | Peak exothermic | 305 | NM* | NM* | NM* | NM* | NM* |
| | Time (in seconds) | | | | | | |
| Lap-shear | 24HRTC** | 19.0 | 0.2 | 0.2 | NM* | 0.8 | NM* |
| strength on mild- | 24HRTC + 3 | 28.3 | 0.3 | 0.3 | NM* | 0.9 | NM* |
| steel substrates | hours@100° C.*** | | | | | | |
| (in N/mm²) | | | | | | | |

Note:
NM* refers to no measurement, since evaluation of the properties was impossible; 24HRTC** refers to curing for 24 hours at room temperature (i.e. 25° C.); and 24HRTC + 3 hours@100° C.*** refers to curing for 24 hours at room temperature and then curing for 3 hours at 100° C.

As illustrated by Ex. 27 in Table 8, by using an amine-aldehyde condensation compound, the two-part adhesive composition according to the present invention exhibited short gel time and peak exothermic time, and high peak exothermic temperature, which correspond to fast curing speed and high curing rate, respectively, and thus are desirable; and the two-part adhesive composition according to the present invention also showed good bonding strength under both 24HRTC and 24HRTC+3 hours@100° C.

In contrast, as illustrated by Ex. 28-32, if an amine-aldehyde condensation compound is replaced with other reducing agents, the two-part adhesive composition neither exhibited short gel time and peak exothermic time and high exothermic temperature, nor showed good bonding strength under both 24HRTC and 24HRTC+3 hours@100° C.

What is claimed is:

1. A (meth)acrylate-based two-part adhesive composition, comprising:
a first part comprising: at least one amine-aldehyde condensation compound, and
a second part comprising: at least one organic transitional metal compound and at least one phosphorus-containing compound,
wherein the first part and/or the second part further comprise at least one (meth)acrylate monomer containing at least one hydroxyl group per molecule.

2. The (meth)acrylate-based two-part adhesive composition according to claim 1, wherein the amine-aldehyde condensation compound is a butyraldehyde-aniline condensation compound.

3. The (meth)acrylate-based two-part adhesive composition according to claim 1, wherein the organic transitional metal compound is selected from vanadium and cuprous complexes.

4. The (meth)acrylate-based two-part adhesive composition according to claim 1, wherein the phosphorus-containing compound is selected from the group consisting of an organic phosphorus-containing compound and an inorganic phosphorus-containing compound.

5. The (meth)acrylate-based two-part adhesive composition according to claim 1, wherein the (meth)acrylate monomer containing at least one hydroxyl group per molecule is a monofunctional (meth)acrylate monomer selected from the group consisting of hydroxyethyl methacrylate and hydroxypropyl methacrylate.

6. The (meth)acrylate-based two-part adhesive composition according to claim 1, wherein the amine-aldehyde condensation compound is present in an amount of 0.3 to 3.5 wt. % based on the total weight of the first part.

7. The (meth)acrylate-based two-part adhesive composition according to claim 1, wherein the organic transitional metal compound is present in an amount of 0.03 to 0.4 wt. % based on the total weight of the second part.

8. The (meth)acrylate-based two-part adhesive composition according to claim 1, wherein the phosphorus-containing compound is present in an amount of 0.2 to 4 wt. % based on the total weight of the second part.

9. The (meth)acrylate-based two-part adhesive composition according to claim 1, wherein the first part and/or the second part further comprise at least one (meth)acrylic resin, at least one toughening agent and/or at least one inhibitor.

10. The (meth)acrylate-based two-part adhesive composition according to claim 1, wherein the composition is free from peroxide and/or amine.

11. The (meth)acrylate-based two-part adhesive composition according to claim 1, wherein the ratio by weight of the first part: the second part is 5:1 to 1:5.

12. The (meth)acrylate-based two-part adhesive composition according to claim 1, comprising:
a first part, based on the total weight of the first part, comprising:
from 30.0 to 90.0 wt % of at least one (meth)acrylate monomer containing at least one hydroxyl group per molecule,
from 5 to 40.0 wt % of at least one (meth)acrylic resin,
from 5 to 30.0 wt % of at least one toughening agent,
from 0.05 to 0.5 wt % of at least one inhibitor, and
from 0.3 to 3.5 wt % of at least one amine-aldehyde condensation compound; and
a second part, based on the total weight of the second part, comprising:
from 30.0 to 90.0 wt % of at least one (meth)acrylate monomer containing at least one hydroxyl group per molecule,
from 5 to 40.0 wt % of at least one (meth)acrylic resin,
from 5 to 30.0 wt % of at least one toughening agent,
from 0.05 to 0.5 wt % of at least one inhibitor,
from 0.03 to 0.4 wt % of at least one organic transitional metal compound, and
from 0.2 to 4 wt % of at least one phosphorus-containing compound.

13. A method for bonding a first substrate to a second substrate, comprising:
mixing the two parts of the (meth)acrylate-based two-part adhesive composition according to claim 1;
applying the mixed adhesive composition to at least one of the substrate surfaces to be bonded;
joining the substrates to be bonded in a way that the adhesive composition is between the substrates; and
curing the adhesive composition.

14. The method according to claim 13, wherein the first substrate and the second substrate are identical or different materials selected from the group consisting of metals, plastics, ceramic, glass and cellulosic materials.

15. An article bonded by the (meth)acrylate-based two-part adhesive composition according to claim 1.
